(19) United States
(12) Patent Application Publication
(10) Pub. No.: US 2014/0131993 A1
(43) Pub. Date: May 15, 2014

(54) BUSHING/COLLET NUT COMPONENT, PLUNGER ADAPTOR/COLLET NUT COMPONENT AND TOP SEAL ASSEMBLY FOR USE WITH A DOWNHOLE PUMP

(71) Applicants: Fernando M. Rubio, JR., Artesia, NM (US); Jaime Huitron, Artesia, NM (US)

(72) Inventors: Fernando M. Rubio, JR., Artesia, NM (US); Jaime Huitron, Artesia, NM (US)

(21) Appl. No.: 13/673,483

(22) Filed: Nov. 9, 2012

(51) Int. Cl. F16L 15/04; F16L 5/02

(52) U.S. Cl. CPC F16L 15/04; F16L 5/02
USPC 285/45; 16/2.1; 285/386

(57) ABSTRACT

The present invention discloses a plunger adaptor/collet nut component that connects to the plunger of a down hole pump on the plunger adaptor end and a pull tube on the collet nut end. The pull tube extends through a top seal assembly and into a bushing/collet nut component located above the top seal assembly. In the preferred embodiment, the plunger adaptor/collet nut component is dimensioned such that a 1.125 inch diameter pull tube can connect to the collet nut while the plunger adaptor is dimensioned such that it can connect to the top of plungers for larger diameter pumps such as 1.75 inch and 2.0 inch down hole pumps. The bushing/collet nut component of the preferred embodiment is dimensioned such that the collet nut attaches to the top of the pull tube guide and permits a 1.125 inch diameter pull tube to pass through it while the bushing is dimensioned to accommodate the smaller 1.125 inch diameter pull tube in place of the larger diameter pull tubes usually associated with larger diameter pump drilling operations.

### CROSS REFERENCE TO RELATED APPLICATIONS

This non-provisional patent application does not claim priority to any United States provisional patent application or any foreign patent application.

### FIELD OF THE DISCLOSURE

The disclosures made herein relate generally to the oil and gas industry. The invention discussed herein is in the general classification of a bushing/collet nut component, plunger adaptor/collet nut component and top seal assembly for use with an oil and gas down hole pump to prevent sand and other solids from lodging around the down hole pump between the pump and tubing.

### BACKGROUND

This section introduces aspects that may be helpful in facilitating a better understanding of the invention. Accordingly, the statements of this section are to be read in this light and are not to be understood as admissions about what is in the prior art or what is not in the prior art.

Casing (e.g. sections of steel pipe) is placed in a borehole after it is drilled. Cement may be placed between the outside of the casing and the borehole. The casing provides additional structural integrity to the well.

After the casing is placed in the borehole, the well is completed to enable it to produce oil or gas. Small perforations are made in the portion of the casing that passes through the production zone in the earth to provide a pathway for the oil to flow from the surrounding rock into the production tubing. A smaller diameter steel pipe (i.e. tubing) is inserted inside the casing and connects the area above the reservoir section of the well to the surface.

The natural pressure of the subsurface oil reservoir is often high enough for the oil or gas to flow to the surface. However, if the use of a smaller diameter tubing is insufficient, artificial lift techniques such as down hole pumps may be required. A pull tube is inserted into the tubing and utilized to connect to the plunger of the down hole pump to allow the oil to be pumped to the surface.

One well known problem when down hole pumps are utilized involves sand and other solid particles from the oil being extracted from the earth becoming lodged between the pump and the tubing. This problem results from oil and sand particles accumulating and settling along the length of the pump in the region beneath the location where oil exits into the tubing above the pump. Because these settled particles around the pump are not constantly being agitated by the emerging oil above them, they have a tendency to harden and make it increasingly difficult to withdraw the pump from the tubing for servicing and regular maintenance. The particles wedged between the pump and tubing may create increases in both the costs and time associated with withdrawing the pump for servicing and regular maintenance and also may cause damage to the pump during the withdrawal process.

There have been several attempts at alleviating this build-up of solid particles around the pump through the years. The most popular solution involves inserting a top seal assembly above the pump but below where oil emerges into the tubing to provide an oil and particle tight seal between the top seal assembly and well tubing above the pump. This top seal assembly is designed to prevent build-up of particles beneath the top seal assembly, including between the pump and tubing. However, this top seal assembly solution is traditionally only employed with smaller diameter down hole pumps because the top seal assembly only accommodates smaller diameter valve rods.

Hence, it would be beneficial to have a bushing, plunger adaptor and top seal assembly that prevents the build-up of solid particles between larger diameter pumps and tubing along the entire length of these pumps during down hole well operations.

There is a need in the art for an easy to use, durable and relatively inexpensive bushing/collet nut component, plunger adaptor/collet nut component and top seal assembly that prevents the build-up of sand, oil and other solid particles around larger diameter down hole pumps.

### SUMMARY OF THE DISCLOSURE

The preferred embodiment of the system utilizes a top seal assembly located above a down hole pump. A plunger adaptor/collet nut component connects to the plunger of the down hole pump on the plunger adaptor end and the pull tube on the collet nut end. The pull tube extends through the top seal assembly and into a bushing/collet nut component located above the top seal assembly.

In the preferred embodiment, the plunger adaptor/collet nut component is dimensioned such that a 1.125 inch diameter pull tube can connect to the collet nut while the plunger adaptor is dimensioned such that it can connect to the top of plungers for larger diameter pumps such as 1.75 inch and 2.0 inch down hole pumps.

In the preferred embodiment, the top seal assembly is dimensioned such that a 1.125 inch diameter pull tube can fit through the wedge ring. This may involve modification (i.e. widening of the hole through the wedge ring of the top seal assembly) to a traditional top seal assembly as it will usually only accommodate a one inch diameter valve rod.

In the preferred embodiment, the bushing/collet nut component is dimensioned such that the collet nut attaches to the top of the pull tube guide and permits a 1.125 inch diameter pull tube to pass through it, and the bushing is dimensioned to accommodate the smaller 1.125 inch diameter pull tube in place of the larger diameter pull tubes usually associated with larger diameter pump drilling operations.

Certain alternative embodiments may utilize a variety of pump, pull tube, top seal assembly, bushing/collet nut component and plunger adaptor/collet nut component dimensions without departing from the spirit of the invention.

Under some applications, embodiments of the invention may provide a bushing/collet nut component, plunger adaptor/collet nut component and top seal assembly for use with larger diameter pumps to prevent the build-up of solid particles between the pumps and tubing.

Under some applications, embodiments of the invention may provide a bushing/collet nut component, plunger adaptor/collet nut component and top seal assembly for use with larger diameter pumps to prevent the build-up of solid particles between the pumps and tubing that can be used at the high temperatures associated with down hole drilling.

Under some applications, embodiments of the invention may provide a bushing/collet nut component, plunger adaptor/collet nut component and top seal assembly for use with larger diameter pumps to prevent the build-up of solid particles between the pumps and tubing that can be used at the high pressures associated with down hole drilling.

Under some applications, embodiments of the invention may provide a relatively easy to use bushing/collet nut component, plunger adaptor/collet nut component and top seal assembly for use with larger diameter pumps to prevent the build-up of solid particles between the pumps and tubing.

Under some applications, embodiments of the invention may provide a reliable to use bushing/collet nut component, plunger adaptor/collet nut component and top seal assembly for use with larger diameter pumps to prevent the build-up of solid particles between the pumps and tubing.

Under some applications, embodiments of the invention may provide a relatively inexpensive to manufacture bushing/collet nut component, plunger adaptor/collet nut component and top seal assembly for use with larger diameter pumps to prevent the build-up of solid particles between the pumps and tubing.

Under some applications, embodiments of the invention may provide a durable bushing/collet nut component, plunger adaptor/collet nut component and top seal assembly for use with larger diameter pumps to prevent the build-up of solid particles between the pumps and tubing.

Under some applications, embodiments of the invention may provide a strong bushing/collet nut component, plunger adaptor/collet nut component and top seal assembly for use with larger diameter pumps to prevent the build-up of solid particles between the pumps and tubing.

### BRIEF DESCRIPTION OF THE DRAWINGS

Some embodiments of apparatus and/or methods of the present invention are now described, by way of example only, and with reference to the accompanying drawings, in which:

FIG. 1 depicts a cross-sectional view of the down hole system of the preferred embodiment.

FIG. 2 depicts a frontal view of the plunger adaptor/collet nut component of the preferred embodiment.

FIG. 3 depicts an overhead view of the plunger adaptor/collet nut component connected to the pull tube of the preferred embodiment.

FIG. 4 depicts a frontal view of the top seal assembly of the preferred embodiment.

FIG. 5 depicts a frontal view of the bushing/collet nut component of the preferred embodiment.

### DETAILED DESCRIPTION OF THE DRAWINGS

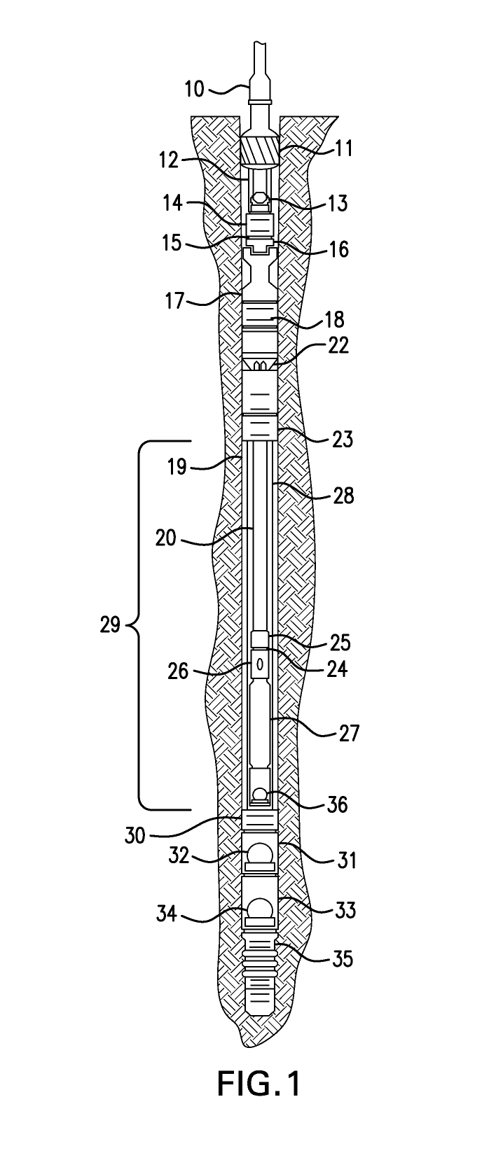

FIG. 1 depicts a cross-sectional view of the down hole system of the preferred embodiment. At the top of the system depicted in FIG. 1, as well known in the industry, a lift sub 10 connects to a spiral 11 that connects to an open end cage 12, containing a ball and seat 13. The open end cage 12 connects to a bushing 14 of the bushing/collet nut component 15. The bushing/collet nut component 15 has a collet nut 16 at the opposite end from the bushing 14 that connects to the pull tube guide 17 and is made of steel in the preferred embodiment.

The pull tube guide 17 connects to the top seal assembly 18. The top seal assembly 18 has a rubber exterior that is designed to conform to the fit of the tubing 19 it is installed inside. The top seal assembly 18 creates a sort of interference fit with the tubing 19 and surrounds the pull tube 20. The pull tube 20 extends through the top seal assembly 18 including the wedge ring 22 centrally located in the top seal assembly 18 and through the barrel adaptor 23 connected to the bottom of the top seal assembly 18.

The pull tube 20 connects to the plunger adaptor/collet nut component 24 at the collet nut 25. The plunger adaptor 26 connects to the plunger 27 located within the pump barrel 28 of the pump 29. The bottom of the plunger 27 is capable of being moved within the pump barrel 28 to the bottom of the pump 29 and has a traveling valve located on the plunger 27 as is well known in the art.

A barrel adaptor 30 connects the bottom of the pump 29 to a primary cage 31 with a ball and seat 32 that connects to a secondary cage 33 with a ball and seat 34 that is attached to a hold down 35 to keep the pump stationary during operation.

In the preferred embodiment, the collet nut 16 has a threaded bottom dimensioned to be inserted and threaded inside the top of the pull tube guide 17. The collet nut 16 outer diameter of the preferred embodiment is approximately two and one quarter inches. The bottom of the pull tube guide 17 is further dimensioned to accept a threaded end of the top seal assembly 18 that typically has an outer diameter of two and one quarter inches. The bottom of the top seal assembly 18 is also threaded and fits within the barrel adaptor 23 dimensioned to accept the threads of the bottom of the top seal assembly 18.

The pump 29 also has threaded ends and is dimensioned to fit within the barrel adaptors 23, 30 on opposite ends of the pump 29. In the preferred embodiment, the outer diameter of the pump barrel 28 is two and one quarter inches for a 1.75 inch pump and two and five-sixteenths inches for a 2.0 inch pump. The interior of the top seal assembly is usually made of steel and terminates with threaded ends on either side while the cover around the top seal assembly 18 is made of rubber.

Oil enters the barrel 28 through the standing valve/ball and seat 36 shown at the bottom of the barrel 28 while the plunger 27 is on its upstroke and the traveling valve on the plunger 27 is closed. When the plunger 27 is on its downstroke through the barrel 28, the traveling valve on the plunger 27 is open and oil enters the plunger 27. When the plunger 27 is on the subsequent upstroke, the traveling valve on plunger 27 closes and the oil within and around the plunger 27 in the barrel 28 is lifted up through the barrel 28 and through the top seal assembly 18 and the pull tube guide 17 and bushing/collet nut component 15 until it exits at the ball and seat 13 located above the top seal assembly 18. As a result, the oil cannot settle down past the top seal assembly 18 located above the pump 29 because the top seal assembly 18 is dimensioned to have the same diameter of the tubing 19, preventing any fluid from leaking past the top seal assembly 18.

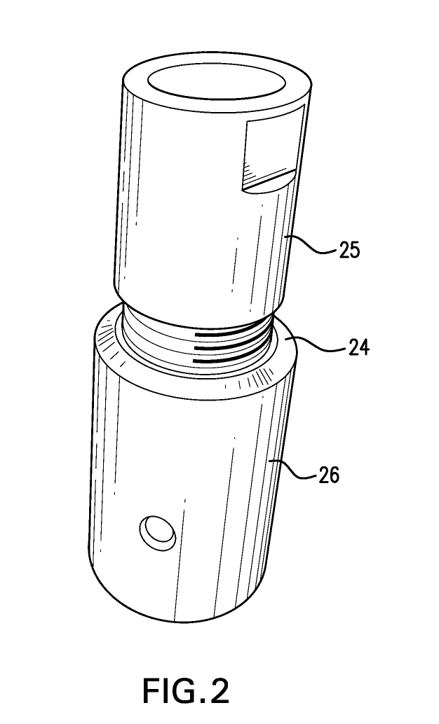

FIG. 2 depicts a frontal view of the plunger adaptor/collet nut component of the preferred embodiment. The plunger adaptor/collet nut component 24 has a collet nut 25 on one end that connects with a pull tube and a plunger adaptor 26 on the opposite end that connects to the plunger of a pump. The collet nut 25 and the plunger adaptor 26 are approximately cylindrical in shape and the entire adaptor/collet nut component 24 is made of steel in the preferred embodiment. The interior of the collet nut 25 is designed to accept the threaded end of a 1.125 inch diameter pull tube while the plunger adaptor is designed to accept the threaded top of a plunger of a 1.75 inch or 2.0 inch diameter pump. As a result, the plunger adaptor 26 and collet nut 25 of the plunger adaptor/collet nut component 24 are not of the same uniform inner diameter (or outer diameter). The plunger adaptor 26 has an inner diameter of 0.75 inch while the collet nut 25 has an inner diameter of 1.125 inches, and the outer diameter of the collet nut 25 is smaller than the outer diameter of the plunger adaptor 26 in the preferred embodiment.

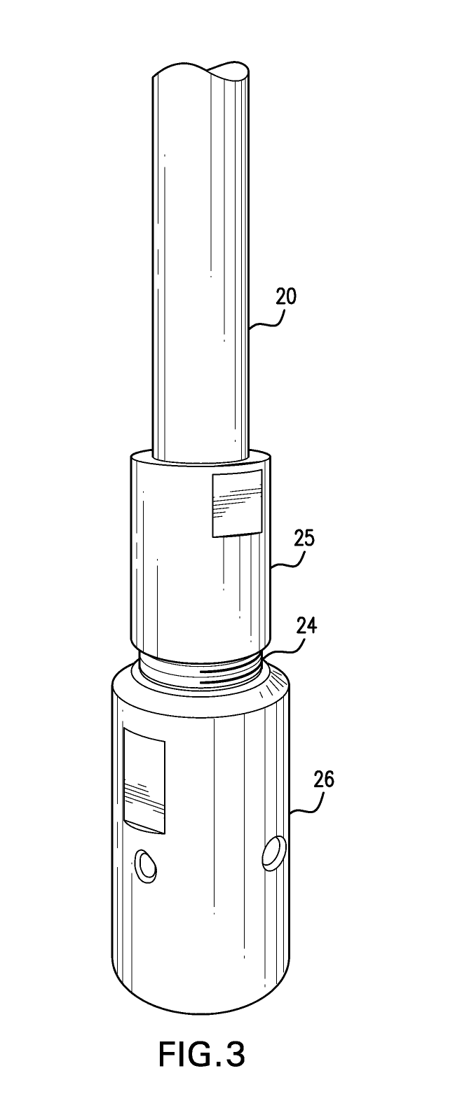

FIG. 3 depicts an overhead view of the plunger adaptor/collet nut component connected to the pull tube of the preferred embodiment. The plunger adaptor/collet nut component 24 has a collet nut 25 on one end that connects with a pull tube 20 and a plunger adaptor 26 on the opposite end that connects to the plunger (not shown) of a pump. The interior of the collet nut 25 is designed to accept the threaded end of a 1.125 inch diameter pull tube 20 while the plunger adaptor 26 is designed to accept the threaded top of a plunger of a 1.75 inch or 2.0 inch diameter pump.

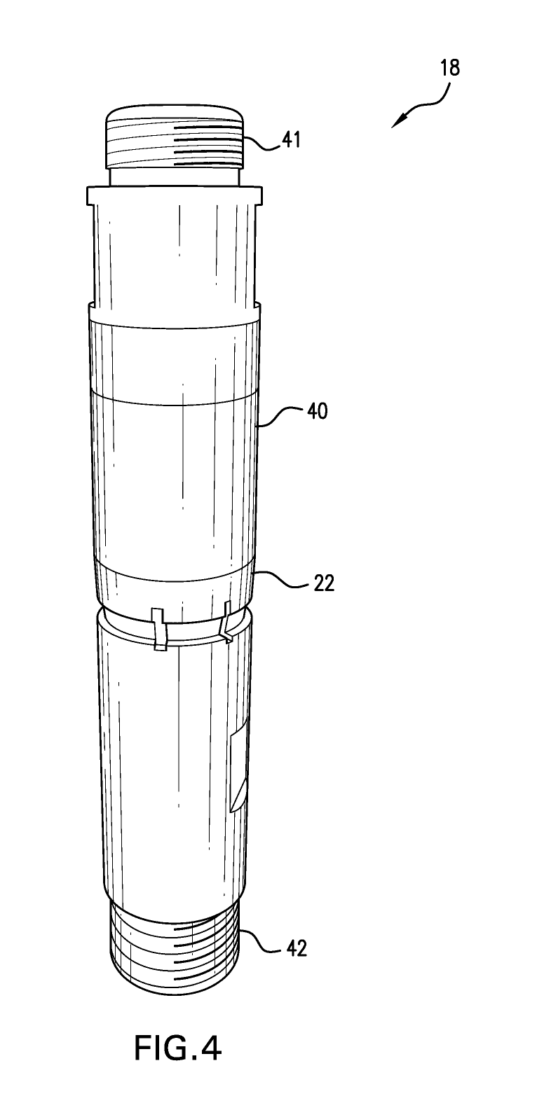

FIG. 4 depicts a frontal view of the top seal assembly of the preferred embodiment. The top seal assembly 18 has threaded ends 41, 42. The threaded end 41 attaches into the bottom of a pull tube guide while the threaded end 42 attaches into the top of a pump barrel adaptor. The threaded ends 41, 42 and the interior of the top seal assembly 18 is made of steel or similar material while the seal 40 on top of the steel interior is made of rubber 40. The top seal assembly 18 is dimensioned to fit precisely within the tubing when installed into the tubing (i.e. press up against the inner diameter of the tubing).

In approximately the center of the top seal assembly 18, a wedge ring 22 reduces the diameter of the top seal assembly 18 such that only a smaller diameter pull tube can fit through the top seal assembly 18. In fact, slight modifications may be necessary to permit a 1.125 inch pull tube to fit through a standard top seal assembly 18 in the form of drilling out the interior of the top seal assembly to slightly enlarge the inner diameter of the wedge ring from 1 inch to 1.125 inches.

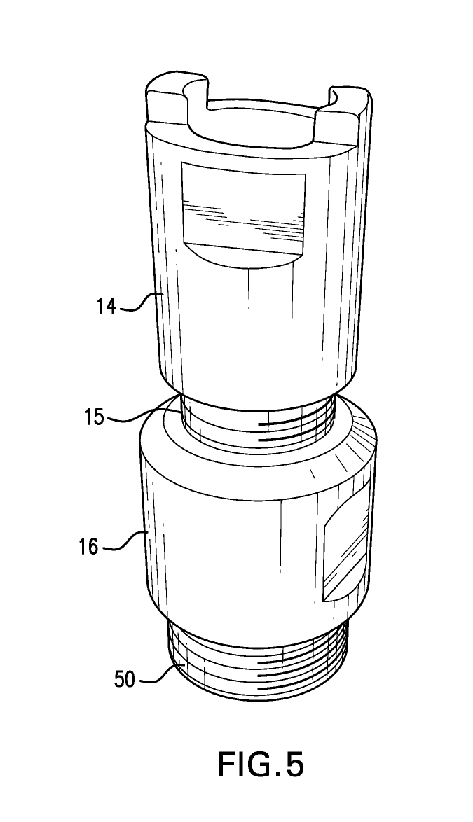

FIG. 5 depicts a frontal view of the bushing/collet nut component of the preferred embodiment. The bushing/collet nut component 15 has an approximately cylindrical bushing 14 and collet nut 16 made of steel. The bushing 14 is dimensioned to permit a 1.125 inch pull tube to fit through the bushing/collet nut component 15 (i.e. it has an approximately 1.125 inch inner diameter). The collet nut 16 is designed to have an inner diameter to accommodate a 1.125 inch pull tube (i.e. it has an approximately 1.125 inch inner diameter) and threaded end to permit it to fit into a pull tube guide normally utilized in conjunction with pull tubes with diameters of 1.125 inches. The threaded bottom 50 of the bushing/collet nut component 15 allows it to be inserted into and connected to the top of the pull tube guide.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A down hole pump system comprising:
(a) a bushing/collet nut component with a bushing on one end with an inner diameter that permits passage of a pull tube and a collet nut on the opposite end that has a threaded end with an inner diameter that permits passage of the pull tube and an outer diameter that permits attachment into a pull tube guide wherein the pull tube guide attaches to a top seal assembly; and
(b) a barrel adaptor that attaches to the top seal assembly on an opposite end from the pull tube guide and to a barrel of a pump wherein a plunger of the pump attaches to a collet nut/plunger adaptor component wherein the collet nut accepts a threaded end of the pull tube and the plunger adaptor accepts the threaded end of the plunger.

2. The down hole pump system of claim 1 wherein the bushing of the bushing/collet nut component has an inner diameter to accommodate a 1.125 inch pull tube.

3. The down hole pump system of claim 2 wherein the collet nut of the bushing/collet nut component has an inner diameter to accommodate a 1.125 inch pull tube and an outer diameter of the threaded end to fit within the pull tube guide for a 1.125 inch pull tube.

4. The down hole pump system of claim 3 wherein the top seal assembly has an inner diameter at a wedge ring centrally located within the top seal assembly to accommodate a 1.125 inch pull tube.

5. The down hole pump system of claim 4 wherein the top seal assembly surrounds the pull tube and has a rubber exterior that creates an interference with a tubing.

6. The down hole pump system of claim 5 wherein the top seal assembly has threaded ends designed to fit within the barrel adaptor and the pull tube guide.

7. The down hole pump system of claim 1 wherein the collet nut of the collet nut/plunger adaptor component is dimensioned to accept a 1.125 inch pull tube and the plunger adaptor is dimensioned to accept the plunger associated with a 1.75 inch diameter pump.

8. The down hole pump system of claim 1 wherein the collet nut of the collet nut/plunger adaptor component is dimensioned to accept a 1.125 inch pull tube and the plunger adaptor is dimensioned to accept the plunger associated with a 2.0 inch diameter pump.

9. A component for use with a down hole pump comprising:
a bushing on one end with an inner diameter that permits passage of a pull tube and a collet nut on the opposite end with an inner diameter that permits passage of the pull tube and a threaded end with an outer diameter that allows it to fit into a pull tube guide for a 1.125 inch pull tube.

10. The component of claim 9 wherein the bushing and the collet nut are approximately cylindrical and made of steel.

11. The component of claim 9 wherein the inner diameter of the bushing accommodates a 1.125 inch pull tube.

12. The component of claim 11 wherein the inner diameter of the collet nut accommodates a 1.125 inch pull tube.

13. A component for use with a down hole pump comprising:
a collet nut dimensioned to accept a threaded end of a 1.125 inch pull tube and a plunger adaptor on the opposite end from the collet nut dimensioned to accept the threaded end of a plunger of a pump.

14. The component of claim 13 wherein the collet nut and the plunger adaptor are approximately cylindrical and made of steel.

15. The component of claim 13 wherein the plunger adaptor is dimensioned to accept the plunger associated with a 1.75 inch diameter pump.

16. The component of claim 13 wherein the plunger adaptor is dimensioned to accept the plunger associated with a 2.0 inch diameter pump.
